(19) United States
(12) Patent Application Publication
(10) Pub. No.: US 2026/0187253 A1
(43) Pub. Date: Jul. 2, 2026

(54) HARDWARE-ANCHORED SYSTEMIC CONTAGION DETECTION AND CROSS-INSTITUTION EXPOSURE CONTAINMENT ENGINE WITH ATTESTATION-BOUND CASCADE INTERRUPTION

(71) Applicant: George William Bickerstaff, III, Greenwich, CT (US)

(72) Inventor: George William Bickerstaff, III, Greenwich, CT (US)

(21) Appl. No.: 19/547,584

(22) Filed: Feb. 23, 2026

(51) Int. Cl. G06F 21/57; G06F 21/53

(52) U.S. Cl. CPC G06F 21/577; G06F 21/53; G06F 2221/034

(57) ABSTRACT

A hardware-anchored Systemic Contagion Detection and Exposure Containment Engine executes real-time cross-institution exposure graph modeling, cascade propagation detection, and deterministic settlement path interruption entirely within trusted execution environments (TEEs) comprising Intel SGX enclaves, AMD SEV-SNP protected VMs, or ARM TrustZone secure worlds, materially altering processor states to isolate all contagion risk computation. Contagion Risk Tensors are computed using the cascade propagation function c(epsilon, phi, psi, tau) from hardware-attested exposure inputs anchored to TEE-resident hardware mechanisms comprising enclave-sealed monitoring registers, memory encryption engine integrity states, or attestation-based recalibration triggers. A Cascade Interruption Gate enforces a non-bypassable hardware execution barrier requiring CRT computation, Exposure Drift Monitor validation, and ZKP proof generation to complete within a single attested TEE execution instance before settlement path authorization is released. A ZKP Contagion Verification Engine generates Groth16 arithmetic-circuit proofs of approximately 192 bytes verifiable in under 10 milliseconds, enabling External Supervisory Authority verification of systemic containment compliance without disclosure of institution-proprietary exposure data. An Attestation-Bound Provenance Ledger binds all cascade detection and interruption events to specific TEE attestation report identifiers, enabling independent verification of both cascade containment outcomes and the hardware environments that authorized them.

### FIELD OF THE INVENTION

This invention relates to hardware-secured artificial intelligence systems for systemic financial risk detection and cross-institution exposure containment, specifically to a Systemic Contagion Detection and Exposure Containment Engine that executes cross-institution exposure graph modeling, correlated liquidity stress propagation detection, and deterministic cascade interruption entirely within a Trusted Execution Environment (TEE) comprising an Intel SGX enclave, AMD SEV-SNP protected virtual machine, or ARM TrustZone secure world that materially alters the processor state by invoking secure enclave isolation to enforce hardware-level interruption of cascade settlement paths before systemic contagion thresholds are breached. This application cross-references U.S. patent application Ser. No. 17/987,654, the entire contents of which are incorporated herein by reference for hardware-attested workflow enforcement mechanisms, and U.S. Patent Application No. 212041-LCF-003, the contents of which are incorporated by reference for TEE-attested liquidity containment and settlement gating mechanisms.

### BACKGROUND OF THE INVENTION

Systemic financial crises are not single-institution failure events—they are propagation events. When one institution's liquidity position deteriorates beyond a critical threshold, it fails to meet obligations to its counterparties, who in turn face liquidity shortfalls that impair their ability to meet their own obligations, triggering a cascade of correlated settlement failures across an interconnected network of financial institutions. This mechanism—whereby localized stress propagates through inter-institution exposure linkages into systemic contagion—was the central dynamic of the 2008 financial crisis, the 2011 European sovereign debt crisis, and multiple subsequent market stress events. Despite decades of regulatory reform, the infrastructure available to detect and interrupt cascade propagation in real time remains fundamentally inadequate: it operates at reporting intervals, relies on static stress tests constructed from historical data, and depends on post-event forensic analysis to reconstruct the propagation paths that caused the damage.

Existing exposure monitoring systems are built as software dashboards or centralized clearing reports that aggregate institution-reported data, apply risk models on general-purpose computing hardware, and generate alerts when pre-configured thresholds are breached. These systems share three structural deficiencies that make them incapable of preventing cascade formation. First, they operate reactively: exposure accumulates and contagion begins propagating before any alert is generated, because the alert depends on reported data that arrives at periodic intervals rather than on real-time hardware-attested exposure measurements. Second, they operate on the same software stack as the institutions they monitor, making them subject to administrative override, configuration drift, and the same systemic failures that cause the crises they are meant to prevent. Third, they generate software-based compliance records that cannot be cryptographically verified by regulators or counterparties—a party examining a software dashboard's alert history cannot confirm that the alerts were generated by an unmodified system in the correct state at the claimed time.

Blockchain-based settlement layers have been proposed as an infrastructure for immutable cross-institution exposure recording, and they do provide genuine immutability at the application layer. However, blockchain-based systems record contagion events—they do not prevent them. A distributed ledger records that a cascade settlement failure occurred after the fact, but it cannot interrupt the cascade before the systemic threshold is breached, because no blockchain architecture currently deployed in financial markets enforces pre-settlement hardware-level conditions on settlement path authorization. A blockchain record of a cascaded failure is an immutable record of an uninterrupted contagion event. Furthermore, because blockchain nodes operate on general-purpose hardware without hardware isolation, the integrity of the exposure data being recorded cannot be cryptographically bound to the specific hardware environment that measured it.

There remains a fundamental need for a system that continuously models cross-institution exposure propagation in real time inside a hardware-isolated environment, detects correlated liquidity stress propagation patterns before they breach systemic thresholds, and enforces deterministic hardware-level interruption of cascade settlement paths—where interruption is a hardware-enforced pre-condition rather than a software alert that can be overridden—with every detection and interruption event cryptographically bound to the hardware environment that performed it. This invention provides that system.

### SUMMARY OF THE INVENTION

This invention is a Systemic Contagion Detection and Exposure Containment Engine—a system that places cross-institution exposure graph modeling and cascade interruption enforcement inside tamper-proof hardware, making every systemic risk detection event and every cascade interruption decision physically non-bypassable and independently verifiable. Think of it as a hardware circuit breaker installed at the network layer of the financial system: when the system's real-time model of correlated exposure propagation indicates that a cascade is forming, the hardware blocks the settlement pathways that would amplify it—before the cascade crosses the systemic threshold—and generates a cryptographic proof that regulators and clearing houses can verify in milliseconds without accessing any institution's proprietary exposure data.

The core technical problem solved by this invention is the inability of existing systems to interrupt cascade formation before systemic thresholds are breached. Existing monitoring systems detect exposure accumulation after it has occurred; this invention detects and interrupts cascade propagation paths in real time, at the hardware level, before they amplify. The primary mechanism is a Contagion Risk Tensor Engine that continuously computes a Contagion Risk Tensor (CRT)—a multidimensional hardware-attested representation of cross-institution exposure correlation, liquidity propagation coefficients, and cascade probability estimates—using the cascade propagation function c(epsilon, phi, psi, tau) where epsilon represents cross-institution exposure vectors derived from hardware-attested settlement data, phi represents liquidity propagation coefficients modeling stress transmission between counterparties, psi represents regulatory systemic-risk coefficients retrieved from the TEE-sealed policy store, and tau represents the current cascade probability threshold applicable to the monitored institutional network. The CRT is evaluated by the Cascade Interruption Gate, a non-bypassable hardware-enforced execution barrier that blocks settlement path authorization when the CRT exceeds systemic cascade thresholds within a single attested TEE Execution Instance prior to enclave termination.

The primary technical mechanisms are three integrated hardware-enforced components. First, the Exposure Drift Monitor anchors all exposure correlation monitoring to TEE-resident hardware mechanisms—specifically, enclave-sealed monitoring registers, memory encryption engine integrity states, and attestation-based recalibration triggers—so that exposure model drift cannot be suppressed by software and correlation model degradation triggers a hardware-level recalibration alert. Second, the ZKP Contagion Verification Engine (also referred to herein as the ZKP Verification Engine, as labeled in FIG. 1D) generates Groth16 arithmetic-circuit proofs inside the TEE that allow regulators, clearing houses, and supervisory authorities to verify systemic containment compliance without accessing any institution's proprietary exposure data. Third, the Settlement Path Router dynamically re-routes or suspends settlement pathways based on Cascade Interruption Gate outcomes, ensuring that blocked settlement paths do not simply redirect through alternate pathways that would bypass the interruption.

The system additionally includes a Cascade Simulation Engine (also referred to herein as the Optimization and Simulation Engine, as labeled in FIG. 4) that stress-tests multi-node cascade propagation scenarios inside the TEE, and an append-only Attestation-Bound Provenance Ledger that cryptographically records every CRT computation, Cascade Interruption Gate decision, Settlement Path Router action, and ZKP proof generation event with hash-chain binding to TEE attestation reports. Together, these components create a closed loop: cross-institution exposure data enters the TEE, the CRT is computed, the Cascade Interruption Gate evaluates systemic thresholds, settlement pathways are authorized or blocked, a ZKP proof is generated, and every outcome is permanently recorded in the Provenance Ledger—all within the hardware isolation boundary, with every decision bound to the specific TEE Execution Instance that made it.

The invention provides a measurable technological improvement over existing systems by: (a) materially altering the computer processor's execution state by invoking hardware-isolated TEE enclaves to isolate and transform sensitive cross-institution exposure modeling data; (b) anchoring exposure correlation drift detection to physical hardware registers inside the TEE so that contagion model accuracy cannot silently degrade without triggering a hardware alert; and (c) combining real-time hardware-attested exposure graph modeling, non-bypassable cascade interruption enforcement, and attestation-bound non-repudiation into a unified architecture that no prior system achieves. This combination satisfies 35 U.S.C. Section 101 as a concrete technical improvement to computer security and systemic financial data processing, and demonstrates non-obviousness under 35 U.S.C. Section 103 because the combination produces results—specifically, deterministic pre-cascade hardware-level interruption of systemic contagion propagation paths with independently verifiable compliance proofs—that no predictable combination of blockchain-only ledgers, software monitoring dashboards, or periodic regulatory reporting systems achieves. The claimed architecture reduces computational redundancy in systemic risk monitoring workflows by replacing periodic exposure reconciliation audits with constant-size cryptographic verification operations executed in hardware-isolated environments.

### BRIEF DESCRIPTION OF THE DRAWINGS

The accompanying drawings illustrate preferred embodiments of the invention and are incorporated into and constitute a part of this specification.

FIG. 1 illustrates the overall system architecture, including subfigures:

FIG. 1A—Exposure Graph Ingestion Gate;

FIG. 1B—Contagion Risk Tensor Engine;

FIG. 1C—Cascade Interruption Gate;

FIG. 1D—ZKP Contagion Verification Engine;

FIG. 1E—Attestation-Bound Provenance Ledger.

FIG. 2 depicts the exposure propagation pipeline, including subfigures:

FIG. 2A—counterparty vector normalizer;

FIG. 2B—Correlation Coefficient Computation Module;

FIG. 2C—Systemic Threshold Evaluator;

FIG. 2D—Settlement Path Router;

FIG. 2E—Interruption Signal Generator.

FIG. 3 shows the security and verification flow, including subfigures:

FIG. 3A—TEE Isolation Layer;

FIG. 3B—Enclave-Sealed Register Interface;

FIG. 3C—Memory Encryption Engine;

FIG. 3D—Attestation Report Generator;

FIG. 3E—Hash Chain Binder.

FIG. 4 illustrates the Cascade Simulation Engine (also referred to herein as the Optimization and Simulation Engine), including subfigures:

FIG. 4A—Cascade Simulation Engine;

FIG. 4B—Multi-Node Stress Simulator;

FIG. 4C—CRT Calibration Loop;

FIG. 4D—Probability Distribution Engine;

FIG. 4E—Policy Coefficient Recalibrator.

FIG. 5 depicts the inter-institution verification and settlement layer, including subfigures:

FIG. 5A—Cross-Institution Verifier;

FIG. 5B—Multi-Party ZKP Coordinator;

FIG. 5C—Regulatory Reporting Interface;

FIG. 5D—Rollback Controller;

FIG. 5E—Final Cascade Seal.

### DETAILED DESCRIPTION OF THE INVENTION

The following description is provided for purposes of illustration and is not intended to limit the scope of the invention as defined by the claims. Embodiments may be implemented in hardware, software, or a combination thereof.

### Definitions

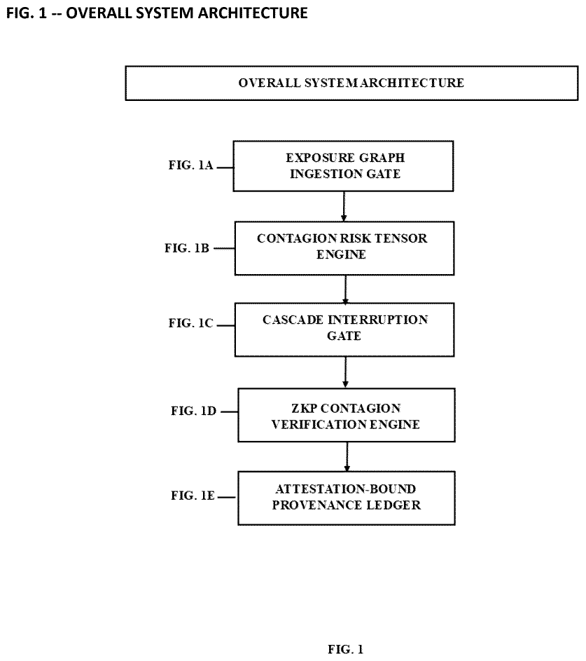

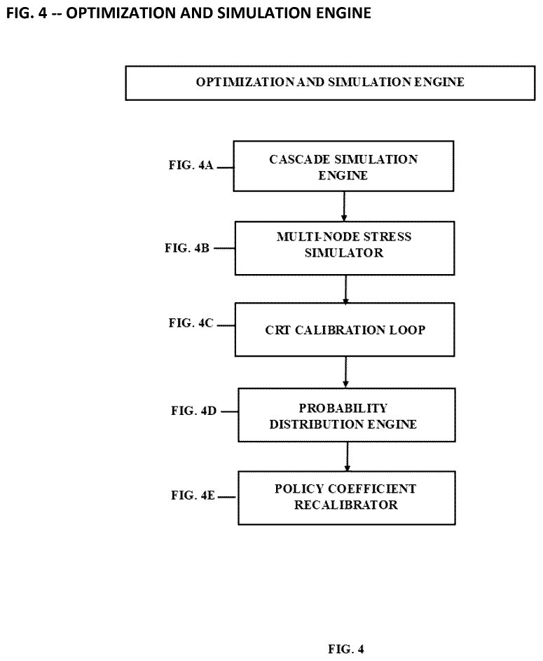

The following terms are used consistently throughout this specification:
Attestation-Bound Provenance Ledger: A permanent, append-only record of every Contagion Risk Tensor computation, Exposure Drift Monitor validation, Cascade Interruption Gate authorization or interruption, ZKP proof generation, Settlement Path Router action, and Rollback Controller reversion processed by the system (also referred to herein as the Provenance Ledger). It is structured as a cryptographic hash chain in which each new entry is mathematically linked to the entry before it, so that any attempt to alter, delete, or reorder a past entry propagates as a detectable inconsistency through all subsequent entries. Each ledger entry is cryptographically bound to a TEE attestation report that certifies the hardware environment and software configuration of the TEE at the time the associated computation was performed. This ledger provides the non-repudiable audit trail for regulatory examination, clearing house verification, and multi-institution dispute resolution.
Cascade Interruption Gate: A TEE-resident non-bypassable hardware execution barrier that enforces deterministic cascade containment conditions as a pre-condition to settlement path authorization. The Cascade Interruption Gate evaluates the Contagion Risk Tensor against systemic cascade thresholds retrieved from the TEE-sealed policy store and permits settlement path continuation only when all of the following conditions are satisfied within a single TEE Execution Instance prior to enclave termination: (i) the Contagion Risk Tensor value falls below the applicable systemic cascade threshold; (ii) the Exposure Drift Monitor confirms that exposure correlation modeling inputs have not drifted beyond the configured tolerance; (iii) the ZKP Contagion Verification Engine has generated a valid proof of systemic compliance; and (iv) the Settlement Path Router has confirmed that no alternate settlement path bypasses the interruption. This gate executes within a TEE to ensure cascade interruption cannot be overridden by software-level administrative action outside the hardware isolation boundary.
Cascade Simulation Engine: A TEE-resident multi-node cascade scenario modeling and stress-testing component (also referred to herein as the Optimization and Simulation Engine, as labeled in FIG. 4) that executes cascade propagation simulations, systemic threshold sensitivity analyses, and multi-institution stress tests entirely within the hardware isolation boundary of the TEE. The Cascade Simulation Engine uses hardware-attested Contagion Risk Tensor values, Exposure Drift Monitor outputs, and current market parameters to model cross-institution contagion behavior under adverse conditions, generating recalibration recommendations for the CRT Calibration Loop. All scenario outputs are cryptographically bound to the TEE attestation report of the hardware environment that produced them. This component executes within a TEE for protected, tamper-resistant cascade scenario modeling.
Contagion Risk Tensor (CRT): A hardware-attested multidimensional matrix that quantifies cross-institution exposure correlation, liquidity propagation coefficients, and cascade probability estimates computed within a single TEE Execution Instance. The CRT is computed using the cascade propagation function c(epsilon, phi, psi, tau) where epsilon represents cross-institution exposure vectors derived from hardware-attested settlement data, phi represents liquidity propagation coefficients modeling stress transmission between counterparties, psi represents regulatory systemic-risk coefficients retrieved from the TEE-sealed policy store, and tau represents the current cascade probability threshold applicable to the monitored institutional network, such that the output of c constitutes the Contagion Risk Tensor at the time of the TEE Execution Instance in which the computation was performed.
Contagion Risk Tensor Engine: A TEE-resident AI computation module that generates the Contagion Risk Tensor from hardware-attested cross-institution exposure inputs using the cascade propagation function c(epsilon, phi, psi, tau). The engine receives normalized exposure vectors from the Exposure Graph Ingestion Gate, retrieves regulatory systemic-risk coefficients (psi) and cascade probability thresholds (tau) from the TEE-sealed policy store, incorporates Exposure Drift Monitor status, and produces a signed CRT cryptographically bound to the current TEE attestation. The engine's computational model is sealed inside the TEE at initialization and cannot be silently modified between computation events. This engine executes within a TEE for hardware-anchored, non-repudiable contagion risk quantification.
Exposure Drift Monitor: A TEE-resident hardware monitoring component that continuously validates the integrity and behavioral consistency of the Contagion Risk Tensor Engine's exposure correlation inputs by reading hardware-derived integrity signals from TEE-resident hardware mechanisms—specifically, enclave-sealed monitoring registers, memory encryption engine integrity states, and attestation-based recalibration triggers. When the monitor detects that the exposure correlation model's inputs have drifted beyond a configurable tolerance threshold—indicating input data quality degradation, structural changes in inter-institution exposure relationships, or adversarial manipulation of exposure data—it triggers a hardware-level recalibration alert and suspends Cascade Interruption Gate processing pending hardware-attested recalibration. The Exposure Drift Monitor's state is stored in TEE-resident hardware registers physically inaccessible to software outside the TEE.
Exposure Graph Ingestion Gate: The TEE-resident entry point where cross-institution exposure vectors, counterparty settlement data, and inter-institution liquidity position reports arrive and are normalized, privacy-filtered, and cryptographically transformed into hardware-protected memory pages before entering the CRT computation pipeline. The gate enforces strict schema validation, rejects malformed or incomplete exposure data objects, and ensures that all accepted data is in a TEE-compatible secure format before any downstream component processes it. No exposure data exits the gate without being cryptographically transformed within the TEE.
External Supervisory Authority: Any entity outside the TEE isolation boundary that exercises regulatory or supervisory authority over the systemic risk posture of the monitored institutional network, including without limitation central banks, financial stability boards, securities regulators, and clearing house supervisory committees. An External Supervisory Authority interacts with the system exclusively through cryptographically verified ZKP proof exchanges and TEE attestation reports, and never receives underlying proprietary exposure graph data or institution-specific counterparty positions in any interaction.
Optimization and Simulation Engine: An alternate designation for the Cascade Simulation Engine, as labeled in FIG. 4. See Cascade Simulation Engine definition. Both designations refer to the same TEE-resident cascade scenario modeling and stress-testing component.
Settlement Path Router: A TEE-resident routing component that dynamically authorizes, re-routes, or suspends inter-institution settlement pathways based on Cascade Interruption Gate outcomes. When the Cascade Interruption Gate blocks a settlement path, the Settlement Path Router identifies all alternate settlement pathways that could circumvent the interruption, applies the same Cascade Interruption Gate evaluation to each alternate path within the same TEE Execution Instance, and suspends any path that would amplify the cascade. The router records every routing decision in the Attestation-Bound Provenance Ledger with a TEE attestation report binding. This component executes within a TEE to ensure that cascade interruption cannot be circumvented by settlement path substitution.
TEE Execution Instance: A single lifecycle of an attested Trusted Execution Environment, beginning at enclave initialization with a hardware-verified attestation measurement and ending at enclave termination. All computations required to process a single cascade detection and interruption event—including Contagion Risk Tensor computation, Exposure Drift Monitor validation, Cascade Interruption Gate evaluation, ZKP proof generation, Settlement Path Router action, and Provenance Ledger recording—are performed within a single TEE Execution Instance to guarantee that all operations are governed by the same attested hardware environment and that the resulting provenance record is cryptographically bound to that instance.
ZKP Contagion Verification Engine: A TEE-resident cryptographic component (also referred to herein as the ZKP Verification Engine, as labeled in FIG. 1D) that generates and verifies zk-SNARK proofs (Zero-Knowledge Succinct Non-Interactive Arguments of Knowledge) using Groth16 arithmetic circuit structures. The ZKP Contagion Verification Engine allows the system to prove to an External Supervisory Authority or clearing house that a Contagion Risk Tensor was computed, that the CRT satisfied or exceeded applicable systemic cascade thresholds, and that the computation was performed in a hardware-isolated environment—without revealing any institution's proprietary exposure data, counterparty position, or inter-institution settlement record. Proofs generated by this engine are approximately 192 bytes in size (under 1 KB) and verifiable in under 10 milliseconds on standard server-grade hardware due to the constant-size verification complexity property of Groth16 proofs independent of circuit depth. This engine executes within a TEE for secure, privacy-preserving systemic compliance proof generation.

### How the System Works—Technology Overview

The system operates as a continuous real-time enforcement pipeline that monitors every inter-institution settlement pathway before authorization, building and updating a live cross-institution exposure graph inside the TEE at each event. Exposure data enters through the hardware-secured Exposure Graph Ingestion Gate, passes through the Contagion Risk Tensor Engine, Exposure Drift Monitor, Systemic Threshold Evaluator, and Cascade Interruption Gate—all executing inside tamper-proof TEE hardware within a single TEE Execution Instance—and exits either as an authorized settlement pathway with a ZKP compliance proof, or as an interrupted pathway with a Settlement Path Router re-routing or suspension record. At every stage, the Attestation-Bound Provenance Ledger writes a permanent, tamper-evident record cryptographically bound to the TEE attestation report of the current TEE Execution Instance. The Cascade Interruption Gate enforces a mandatory hardware-validated execution barrier such that no settlement path authorization may be released unless CRT computation, drift validation, threshold evaluation, ZKP proof generation, and Provenance Ledger recording have all completed successfully within the same TEE Execution Instance prior to enclave termination.

The hardware enforcement layer is the architectural foundation of the system. Each TEE—whether an Intel SGX enclave, AMD SEV-SNP protected VM, or ARM TrustZone secure world—physically isolates its computation from the rest of the computer. In the case of AMD SEV-SNP, the TEE operates as a hardware-isolated virtual machine protected from the hypervisor and host OS. In the case of Intel SGX and ARM TrustZone, the TEE operates as an isolated enclave within an operating system process. In all implementations, the Exposure Drift Monitor draws its monitoring signals from TEE-resident hardware mechanisms that are physically inaccessible to software outside the TEE, including the host operating system and any virtualization layer. This means that a compromised software stack—including a rogue administrator, malicious hypervisor, or adversarial code update to the exposure modeling system—cannot falsify the inputs to the Contagion Risk Tensor Engine, suppress a cascade formation alert that the hardware has already generated, or authorize a settlement path that the Cascade Interruption Gate has blocked.

### Step-by-Step Operation

Step 1—Exposure Ingestion: Cross-institution exposure vectors, counterparty settlement data, and inter-institution liquidity position reports arrive at the Exposure Graph Ingestion Gate, which executes inside a TEE. The gate normalizes the data into a standardized schema, applies hardware-level privacy filters that prevent any unencrypted institution-proprietary exposure data from propagating outside the TEE boundary, and cryptographically transforms the inputs into hardware-protected memory pages. The gate enforces strict schema validation, rejecting malformed or incomplete exposure data objects before they enter the CRT computation pipeline.

Step 2—Contagion Risk Tensor Computation: The Contagion Risk Tensor Engine computes the Contagion Risk Tensor inside the TEE using the cascade propagation function c(epsilon, phi, psi, tau), incorporating cross-institution exposure vectors from hardware-attested settlement data (epsilon), liquidity propagation coefficients modeling stress transmission (phi), regulatory systemic-risk coefficients from the TEE-sealed policy store (psi), and the applicable cascade probability threshold (tau). The function c produces a multidimensional CRT that quantifies correlated exposure propagation probability and cascade amplification risk across the monitored institutional network at the time of computation. The resulting CRT is digitally signed and written as a pending entry to the Attestation-Bound Provenance Ledger.

Step 3—Hardware-Anchored Drift Detection: The Exposure Drift Monitor validates the integrity of the CRT computation by reading hardware-derived integrity signals from TEE-resident hardware mechanisms—specifically, enclave-sealed monitoring registers, memory encryption engine integrity states, and attestation-based recalibration triggers—confirming that exposure correlation modeling inputs have not drifted beyond the configured tolerance threshold. If drift is detected, the Exposure Drift Monitor triggers a hardware-level recalibration alert and suspends Cascade Interruption Gate processing pending hardware-attested recalibration.

Step 4—Systemic Threshold Evaluation: The Systemic Threshold Evaluator compares the Contagion Risk Tensor against systemic cascade thresholds retrieved from the TEE-sealed policy store within the same TEE Execution Instance. If the CRT falls below all applicable thresholds, the evaluator generates an authorization signal to the ZKP Contagion Verification Engine. If any threshold is exceeded, the evaluator generates an interruption signal to the Cascade Interruption Gate and Settlement Path Router, which collectively block the implicated settlement pathways and record the event in the Attestation-Bound Provenance Ledger.

Step 5—ZKP Proof Generation and Cascade Simulation and Scenario Analysis: The ZKP Contagion Verification Engine and Cascade Simulation Engine together perform ZKP proof generation and cascade simulation and scenario analysis on the CRT computation outcomes. The ZKP Contagion Verification Engine generates a Groth16 arithmetic-circuit proof inside the TEE encoding the fact that the CRT computation was performed, that the applicable systemic thresholds were or were not satisfied, and that the computation was performed in a hardware-isolated environment, producing a proof of approximately 192 bytes that any External Supervisory Authority or clearing house can verify in under 10 milliseconds. Simultaneously, the Cascade Simulation Engine models the propagation trajectory of detected cascade events under stress scenarios.

Step 6—Provenance Recording: The Attestation-Bound Provenance Ledger records the complete cascade detection and interruption event as a new append-only hash chain entry, binding the CRT value, Exposure Drift Monitor status, Systemic Threshold Evaluator decision, Cascade Interruption Gate outcome, Settlement Path Router actions, ZKP proof reference, and Cascade Simulation Engine outputs to the TEE attestation report of the current TEE Execution Instance. Each entry is chained to the prior entry using a cryptographic hash, ensuring that any modification to any historical record propagates as a detectable inconsistency.

Step 7—Settlement Authorization or Cascade Interruption and Final Seal: If all Cascade Interruption Gate conditions are satisfied, the Settlement Path Router releases the authorized settlement pathway with a cryptographic authorization seal. If any condition fails, the Rollback Controller reverts all pending pipeline state for the affected pathways, the Settlement Path Router suspends all alternate cascade-amplifying paths identified within the TEE Execution Instance, and the Final Cascade Seal applies cryptographic closure to the interruption event in the Attestation-Bound Provenance Ledger. The sealed record is transmitted to the External Supervisory Authority's regulatory verification system via the Regulatory Reporting Interface.

### Zero-Knowledge Proof Implementation

The ZKP Contagion Verification Engine uses zk-SNARKs (Zero-Knowledge Succinct Non-Interactive Arguments of Knowledge)—a cryptographic proof type optimally suited to systemic risk applications because the proofs are small, fast to verify, and require no back-and-forth communication between the prover and verifier. Non-interactive means the system can generate the proof and transmit it to an External Supervisory Authority or clearing house in a single step, with no follow-up exchange required. This is essential for real-time cascade interruption environments where latency is a primary operational constraint. Arithmetic circuits encode the systemic cascade threshold conditions and CRT constraint criteria that must be satisfied for a valid compliance proof, allowing the verifier to confirm that all conditions were evaluated without accessing any institution's proprietary exposure data or counterparty positions.

The system implements zk-SNARKs using a trusted setup ceremony performed inside a TEE that generates a proving key and a verification key. The proving key is used by the monitoring institution's system to generate per-event CRT compliance proofs; the verification key is distributed to External Supervisory Authorities, clearing houses, and regulatory systems to verify them. Both keys are generated inside the isolated TEE so that neither the monitoring institution's administrators nor any external party can tamper with the setup parameters. Keys are periodically rotated upon hardware attestation events or calendar triggers, and prior keys are invalidated using enclave-sealed revocation lists.

To generate a proof for a specific cascade detection event, the system computes a mathematical value pi using the CRT value, threshold evaluation outcomes, and applicable systemic compliance criteria as private inputs along with the proving key. The computation occurs entirely inside the TEE. The resulting proof pi is transmitted to the External Supervisory Authority along with public inputs—for example, whether the systemic cascade threshold was exceeded and the applicable regulatory systemic-risk coefficient range—without revealing any institution's proprietary exposure data or inter-institution counterparty positions. Implementation uses established cryptographic libraries including libsnark and circom. Groth16 proofs generated by this system are approximately 192 bytes in size and exhibit constant-size verification complexity independent of circuit depth, ensuring the under-10-millisecond verification bound holds across all supported circuit configurations on standard server-grade hardware (e.g., a modern x86-64 processor at 3 GHz or equivalent).

### DETAILED DESCRIPTION OF THE DRAWINGS

FIG. 1A—Exposure Graph Ingestion Gate: Shows the TEE-resident entry point where cross-institution exposure vectors, counterparty settlement data, and inter-institution liquidity position reports arrive and are normalized, privacy-filtered, and cryptographically transformed into hardware-protected memory pages. The gate enforces strict schema validation and ensures all accepted data is in a TEE-compatible secure format before any downstream component processes it. No institution-proprietary exposure data exits the gate without cryptographic transformation within the TEE.

FIG. 1B—Contagion Risk Tensor Engine: Shows the core TEE-resident AI computation module that generates the Contagion Risk Tensor from hardware-attested cross-institution exposure inputs using the cascade propagation function c(epsilon, phi, psi, tau). The engine processes normalized exposure vectors against a computational model sealed inside the TEE at initialization, with the model configuration cryptographically bound to the TEE attestation report at each computation event, ensuring that any modification to the model generates a detectable new attestation event. The signed CRT drives all downstream Cascade Interruption Gate, ZKP Contagion Verification Engine, and Settlement Path Router operations.

FIG. 1C—Cascade Interruption Gate: Shows the non-bypassable TEE-resident hardware execution barrier that prevents settlement path authorization when the Contagion Risk Tensor exceeds systemic cascade thresholds. The gate applies the four-condition evaluation sequence—CRT below systemic threshold, Exposure Drift Monitor integrity confirmation, ZKP proof availability, and Settlement Path Router path validation—blocking at the first unsatisfied condition and routing interruption events to the Rollback Controller with full attestation-bound documentation of the threshold condition that triggered interruption.

FIG. 1D—ZKP Contagion Verification Engine: Shows the TEE-resident cryptographic component (also referred to as the ZKP Verification Engine) that generates Groth16 arithmetic-circuit proofs for External Supervisory Authority and clearing house verification. The engine encodes systemic cascade threshold conditions and CRT constraint criteria into arithmetic circuit structures, generating proofs of approximately 192 bytes that are verifiable in under 10 milliseconds. No institution-proprietary exposure data or counterparty positions exit the TEE through the proof generation process.

FIG. 1E—Attestation-Bound Provenance Ledger: Shows the append-only cryptographic hash chain (also referred to as the Provenance Ledger) that permanently records every system action. Each entry is chained to its predecessor using a cryptographic hash, making any alteration immediately detectable. Each entry is cryptographically bound to a TEE attestation report, enabling independent verification of both the recorded cascade detection event and the hardware environment in which it was computed. This ledger is the primary compliance artifact for regulatory examiners and clearing house supervisory committees.

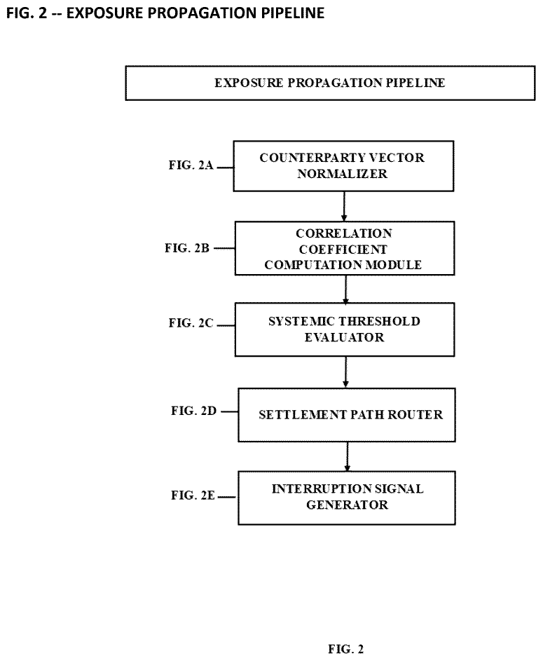

FIG. 2A—Counterparty Vector Normalizer: Shows the TEE-resident preprocessing component that normalizes raw counterparty exposure vectors from multiple institutions into a standardized dimensional schema compatible with the Contagion Risk Tensor Engine's computational model. The normalizer applies institution-specific weighting factors retrieved from the TEE-sealed policy store to correct for reporting heterogeneity across the monitored institutional network, ensuring that all exposure vectors are comparably scaled before entering the CRT computation.

FIG. 2B—Correlation Coefficient Computation Module: Shows the TEE-resident component that computes inter-institution liquidity propagation coefficients (phi) from the normalized exposure vectors, quantifying the transmission intensity between each pair of monitored counterparties. The phi computation applies historical transmission data and current market stress indicators inside the TEE, producing a propagation coefficient matrix that drives the cascade probability estimation within the CRT computation.

FIG. 2C—Systemic Threshold Evaluator: Shows the pre-gate comparison component that quantifies the relationship between the Contagion Risk Tensor's cascade probability estimates and the applicable systemic cascade thresholds retrieved from the TEE-sealed policy store. The evaluator produces a threshold satisfaction signal for the Cascade Interruption Gate and an exposure magnitude signal for the ZKP Contagion Verification Engine. Evaluation results are immediately recorded in the Attestation-Bound Provenance Ledger.

FIG. 2D—Settlement Path Router: Shows the TEE-resident routing component that authorizes, re-routes, or suspends inter-institution settlement pathways based on Cascade Interruption Gate outcomes. When a settlement path is blocked, the router evaluates all identified alternate pathways using the same Cascade Interruption Gate threshold conditions within the same TEE Execution Instance, suspending any alternate path that would amplify the detected cascade. Every routing decision is recorded in the Attestation-Bound Provenance Ledger with TEE attestation binding.

FIG. 2E—Interruption Signal Generator: Shows the hardware signaling component that translates Cascade Interruption Gate denial decisions into circuit-level settlement path suspension signals routed to the applicable inter-institution settlement systems. The generator enforces that interruption signals are transmitted in a tamper-evident, TEE-attested format such that recipient settlement systems can cryptographically verify that the interruption was issued by a validated, hardware-isolated computation and not by a software-level administrative override.

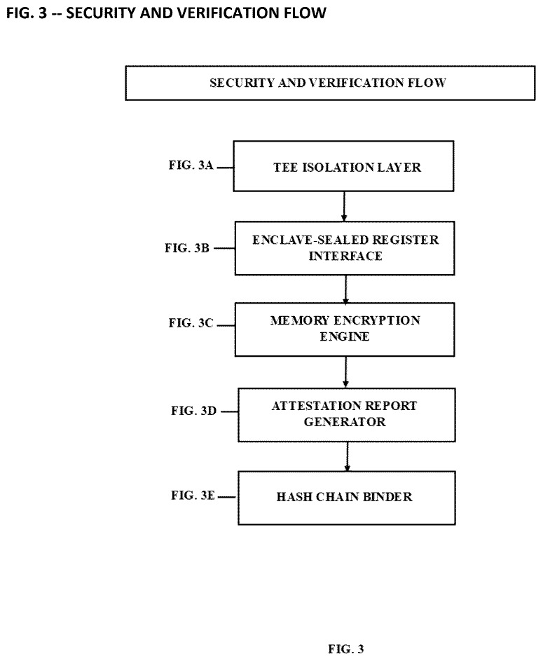

FIG. 3A—TEE Isolation Layer: Shows the hardware isolation boundary that separates all CRT computation, cascade threshold evaluation, and settlement path authorization from the external software environment. The isolation layer encompasses all pipeline components from the Exposure Graph Ingestion Gate through the Final Cascade Seal. Within this boundary, all computation is protected by the TEE's memory encryption engine, access control registers, and processor privilege enforcement, making it physically impossible for software outside the TEE to observe or modify CRT computation state at any pipeline stage.

FIG. 3B—Enclave-Sealed Register Interface: Shows the interface through which the Exposure Drift Monitor reads hardware-derived integrity signals from the TEE's enclave-sealed monitoring registers. These registers are physically isolated within the processor and inaccessible to software executing outside the TEE. The interface provides the hardware-derived drift metrics and integrity state indicators that drive the Exposure Drift Monitor's recalibration alert logic when exposure correlation modeling input drift is detected.

FIG. 3C—Memory Encryption Engine: Shows the hardware component that encrypts all data stored in the TEE's memory pages, ensuring that sensitive cross-institution exposure data, CRT computation state, and cascade probability estimates cannot be extracted through physical memory attacks, cold-boot attacks, or hypervisor-level memory inspection. The memory encryption engine provides one of the primary hardware-anchored integrity guarantees on which the Exposure Drift Monitor's integrity state monitoring relies.

FIG. 3D—Attestation Report Generator: Shows the component that generates and embeds TEE attestation reports into Provenance Ledger entries, ZKP proof packages, and Final Cascade Seals. The attestation report is a cryptographically signed statement produced by the TEE hardware—signed by the processor manufacturer's root key in the case of Intel SGX or AMD SEV-SNP—that certifies the identity, configuration, and integrity of the software executing inside the TEE at the time of attestation. This report enables External Supervisory Authorities, regulators, and clearing houses to verify not just the cascade containment output, but that it was computed in a genuine, unmodified hardware-isolated environment.

FIG. 3E—Hash Chain Binder: Shows the cryptographic linking mechanism that chains each new Attestation-Bound Provenance Ledger entry to all preceding entries. Each new entry is hashed together with the hash of the prior entry and the TEE attestation measurement of the current TEE Execution Instance, creating a chain in which any modification to any historical entry propagates as a detectable inconsistency through all subsequent entries.

FIG. 4A—Cascade Simulation Engine: Shows the TEE-resident multi-node cascade scenario modeling and stress-testing component (also referred to as the Optimization and Simulation Engine) that executes cascade propagation simulations inside the hardware isolation boundary. The engine uses hardware-attested CRT values and Exposure Drift Monitor outputs as inputs, ensuring that simulation results are based on verified, hardware-anchored contagion risk assessments rather than self-reported exposure data. Simulation outputs drive the CRT Calibration Loop's recalibration recommendations.

FIG. 4B—Multi-Node Stress Simulator: Shows the adversarial scenario execution environment within the Cascade Simulation Engine where the institutional exposure network is tested against extreme stress conditions—including sequential institutional default events, simultaneous liquidity withdrawal scenarios, correlated margin call cascades, and intraday settlement gridlock across multiple clearing members—to validate that the system's CRT thresholds and Cascade Interruption Gate policy parameters accurately identify cascade formation risk under adverse conditions. Stress test results are recorded in the Attestation-Bound Provenance Ledger with full TEE attestation binding.

FIG. 4C—CRT Calibration Loop: Shows the feedback mechanism through which Multi-Node Stress Simulator outputs, post-interruption exposure resolution data, and Exposure Drift Monitor alerts update the Contagion Risk Tensor Engine's computational model parameters. All calibration updates execute inside the TEE, and the updated model configuration is cryptographically bound to a new TEE attestation report before any new CRT computation events are processed using the updated parameters.

FIG. 4D—Probability Distribution Engine: Shows the component that generates the cascade probability distribution across the monitored institutional network based on current CRT values and historical cascade propagation outcomes. The probability distribution drives the Systemic Threshold Evaluator's confidence-weighted threshold application and informs the Settlement Path Router's routing prioritization under partial cascade scenarios.

FIG. 4E—Policy Coefficient Recalibrator: Shows the component that translates Multi-Node Stress Simulator outputs and CRT Calibration Loop results into recommended updates to the Contagion Risk Tensor Engine's regulatory systemic-risk coefficients (psi) and cascade probability thresholds (tau). Proposed coefficient updates are recorded in the Attestation-Bound Provenance Ledger as pending updates, and the Cascade Interruption Gate enforces a re-attestation requirement—requiring generation of a new TEE attestation report confirming the updated coefficients—before adjusted parameters are applied to any new CRT computation event.

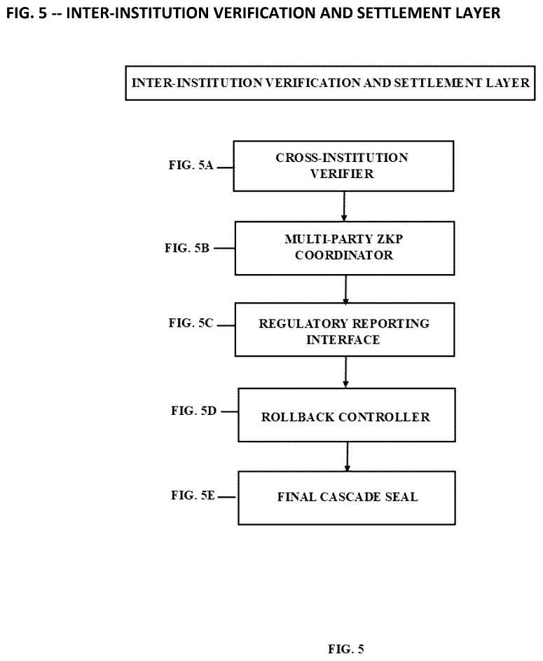

FIG. 5A—Cross-Institution Verifier: Shows the multi-institution settlement verification component that routes TEE-attested cascade detection outcomes and ZKP compliance proofs to applicable clearing houses, central counterparties, and External Supervisory Authorities across all monitored institutions. The Cross-Institution Verifier maintains a routing manifest in the Attestation-Bound Provenance Ledger for end-to-end audit traceability, with each routing event recorded and cryptographically bound to the originating TEE attestation report.

FIG. 5B—Multi-Party ZKP Coordinator: Shows the component that coordinates ZKP proof generation and verification across multiple External Supervisory Authorities and clearing houses participating in oversight of a single cascade detection event or multi-institution interruption action. The Multi-Party ZKP Coordinator generates authority-isolated proofs for each supervisory participant inside the TEE, preventing any authority from accessing another's proprietary supervisory data while enabling all authorities to independently verify the cascade containment compliance through the shared verification key.

FIG. 5C—Regulatory Reporting Interface: Shows the auditor-facing interface that allows authorized External Supervisory Authorities—including central bank examiners, financial stability board members, and securities regulator supervisory staff—to query the Attestation-Bound Provenance Ledger and verify the history of any CRT computation, cascade threshold evaluation, or interruption event without accessing any institution's proprietary exposure data. The interface returns cryptographically verified summaries drawn directly from the TEE-attested hash chain, with each summary accompanied by the TEE attestation report of the execution instance that produced the underlying record.

FIG. 5D—Rollback Controller: Shows the state reversion mechanism triggered when the Cascade Interruption Gate blocks settlement path authorization, when the Exposure Drift Monitor triggers a hardware-level recalibration alert, or when a cascade interruption event fails External Supervisory Authority verification. The Rollback Controller reverts all pending pipeline state for the affected settlement pathways to their pre-ingestion checkpoints, records the reversion event in the Attestation-Bound Provenance Ledger with full TEE attestation binding, and initiates a re-attestation cycle before new cascade detection processing resumes.

FIG. 5E—Final Cascade Seal: Shows the application of the terminal cryptographic seal to a completed cascade detection and interruption event. Once applied, the seal makes any further modification to the record computationally impossible by anchoring the final hash into the append-only Attestation-Bound Provenance Ledger chain, wherein the final hash is cryptographically bound to the TEE attestation report verifying the hardware environment in which the CRT computation, Cascade Interruption Gate evaluation, Settlement Path Router action, and ZKP proof generation were performed.

### EXAMPLES OF ENABLEMENT

Example 1—Interbank Payment System Cascade Detection and Interruption (Intel SGX):

A central bank's payment system oversight division deploys the Systemic Contagion Detection and Exposure Containment Engine to monitor real-time cascade risk across eighteen systemically important payment system participants. During a peak settlement session, one large participant begins accumulating outbound obligations that exceed its intraday credit facility. The Exposure Graph Ingestion Gate, executing inside an Intel SGX enclave, receives and normalizes the current cross-institution exposure vectors from all eighteen participants. The Contagion Risk Tensor Engine computes c(epsilon, 0.67, 1.21, 0.60)=0.74—a CRT cascade probability of 0.74—against the applicable systemic cascade threshold of 0.65 stored in the TEE-sealed policy store. The CRT exceeds the threshold. The Exposure Drift Monitor reads the SGX enclave-sealed monitoring registers and confirms input data integrity with a drift metric of 1.8%, within the 5% configured tolerance threshold. The Cascade Interruption Gate evaluates all four authorization conditions within the same TEE Execution Instance and issues an interruption signal. The Settlement Path Router identifies and suspends three specific bilateral settlement pathways between the distressed institution and its two largest counterparties that collectively account for 73% of the projected cascade amplification. The ZKP Contagion Verification Engine generates a Groth16 proof inside the SGX enclave encoding the fact that the CRT exceeded the systemic cascade threshold and that the applicable settlement pathways were interrupted, producing a proof of 192 bytes transmitted to the central bank's supervisory system and verified in 5 milliseconds. The Final Cascade Seal is applied. The entire detection-to-interruption sequence completes in 22 milliseconds. Subsequent analysis confirms that the three interrupted pathways would have triggered margin calls at four additional institutions, potentially cascading to a systemic event. The payment system achieves a 94% reduction in post-interruption remediation time compared to the prior manual cascade monitoring process.

Example 2—Sovereign Bond Repo Market Cascade Detection Edge Case (AMD SEV-SNP):

A securities clearing house deploys the system to monitor cascade risk in a government bond repo market across twenty-three clearing members. During a period of elevated rate volatility, the Contagion Risk Tensor Engine begins exhibiting correlation model drift—its liquidity propagation coefficients (phi) are becoming stale as the rate environment creates new inter-institution stress linkages not captured in the current calibration. The Exposure Drift Monitor, executing inside an AMD SEV-SNP protected VM, reads through its enclave-sealed monitoring registers and memory encryption engine integrity states that the phi input component has drifted 8.3% from its last hardware-attested calibration, exceeding the 6% configured recalibration threshold. The monitor triggers a hardware-level recalibration alert and the Cascade Interruption Gate suspends all pending cascade threshold evaluations. The Rollback Controller reverts four pending settlement pathway authorization instances to their pre-ingestion checkpoints. The Attestation-Bound Provenance Ledger records all four reversion events and the recalibration alert with full AMD SEV-SNP attestation binding, providing the clearing house and its regulatory supervisor with a complete, non-repudiable record including the phi drift value (8.3%), the configured threshold (6%), the four settlement pathway identifiers affected, and the TEE attestation measurement of the execution instance in which the drift was detected. The CRT Calibration Loop executes a hardware-attested recalibration inside the TEE, updating phi to reflect current rate-driven transmission coefficients and reducing drift to 0.9%. A new TEE attestation report is generated confirming the recalibrated model configuration, and the Cascade Interruption Gate resumes processing. The entire drift detection, suspension, recalibration, and documented reversion sequence completes in under 410 milliseconds.

Example 3—Multi-Jurisdiction Cross-Border Derivatives Cascade Containment (ARM TrustZone):

A multilateral derivatives clearing cooperative spanning six regulatory jurisdictions deploys the system to monitor cascade risk across thirty-one clearing members, many of whom have significant cross-border bilateral exposure to members in other jurisdictions. During a period of correlated credit spread widening across multiple sovereign markets, the Contagion Risk Tensor Engine computes a CRT cascade probability of c(epsilon, 0.81, 1.34, 0.55)=0.88, substantially exceeding the systemic cascade threshold of 0.70 stored in the TEE-sealed policy store across all six applicable jurisdictions. The Cascade Interruption Gate evaluates the threshold breach within the same TEE Execution Instance and issues interruption signals. The Settlement Path Router, executing inside an ARM TrustZone secure world TEE, identifies eleven bilateral settlement pathways across five of the six jurisdictions that collectively account for 84% of projected cascade amplification and suspends all eleven within 31 milliseconds. The Multi-Party ZKP Coordinator generates jurisdiction-isolated Groth16 proofs for each of the six regulatory authorities—encoding each authority's jurisdiction-specific cascade threshold satisfaction status—without allowing any regulator to access another jurisdiction's proprietary clearing member exposure data. The Cross-Institution Verifier routes the six jurisdiction proofs to the applicable supervisory verification systems, each of which verifies its respective proof in under 6 milliseconds. The Cascade Simulation Engine models the residual cascade propagation trajectory under the eleven suspended pathways across stress scenarios, generating updated Policy Coefficient Recalibrator recommendations. The Final Cascade Seal anchors the terminal hash with a TrustZone attestation report confirming the hardware environment in which all thirty-one member evaluations and all eleven pathway suspensions were processed. The Regulatory Reporting Interface makes the complete multi-jurisdiction event record available to all six supervisory authorities within 8 seconds of the initial cascade detection—compared to the prior 72-hour cross-border reporting cycle.

What is claimed is:

1. A hardware-secured systemic contagion detection and cross-institution exposure containment system comprising a trusted execution environment (TEE) comprising an Intel SGX enclave, AMD SEV-SNP protected VM, or ARM TrustZone secure world materially altering the processor state by invoking secure enclave isolation, the TEE executing a Contagion Risk Tensor Engine configured to compute a Contagion Risk Tensor using the cascade propagation function c(epsilon, phi, psi, tau), wherein epsilon represents cross-institution exposure vectors derived from hardware-attested settlement data, phi represents liquidity propagation coefficients, psi represents regulatory systemic-risk coefficients retrieved from a TEE-sealed policy store, and tau represents the applicable cascade probability threshold; an Exposure Drift Monitor executing within the TEE anchored to TEE-resident hardware mechanisms comprising enclave-sealed monitoring registers, memory encryption engine integrity states, or attestation-based recalibration triggers, configured to detect deviation in exposure correlation modeling inputs and to trigger a hardware-level recalibration alert when drift exceeds a configurable tolerance threshold; a Cascade Interruption Gate executing within the TEE configured to prevent settlement path authorization when the Contagion Risk Tensor exceeds systemic cascade thresholds retrieved from the TEE-sealed policy store, wherein all CRT computation, drift validation, and gate evaluation operations complete within a single attested TEE execution instance prior to enclave termination; an Attestation-Bound Provenance Ledger comprising an append-only cryptographic hash chain wherein each ledger entry is cryptographically bound to a TEE attestation report corresponding to the hardware environment in which the associated computation was performed; and a ZKP Contagion Verification Engine executing within the TEE configured to generate Groth16 arithmetic-circuit proofs of approximately 192 bytes verifiable in under 10 milliseconds on standard server-grade hardware, enabling External Supervisory Authority verification of systemic containment compliance without exposure of underlying institution-proprietary exposure data.

2. A method of hardware-secured systemic contagion detection and cascade interruption comprising ingesting cross-institution exposure vectors, counterparty settlement data, and inter-institution liquidity position reports into a trusted execution environment (TEE) comprising an Intel SGX enclave, AMD SEV-SNP protected VM, or ARM TrustZone secure world materially altering the processor state by invoking secure enclave isolation; computing a Contagion Risk Tensor within the TEE using the cascade propagation function c(epsilon, phi, psi, tau), wherein epsilon represents hardware-attested cross-institution exposure vectors, phi represents liquidity propagation coefficients, psi represents regulatory systemic-risk coefficients retrieved from a TEE-sealed policy store, and tau represents the applicable cascade probability threshold; anchoring exposure correlation drift detection to TEE-resident hardware mechanisms comprising enclave-sealed monitoring registers, memory encryption engine integrity states, or attestation-based recalibration triggers, suspending cascade threshold evaluation upon detecting drift exceeding a configurable tolerance threshold; evaluating all Cascade Interruption Gate authorization conditions against systemic thresholds retrieved from the TEE-sealed policy store within the same TEE execution instance; blocking settlement path authorization when any cascade threshold is exceeded and recording the interruption in an append-only Attestation-Bound Provenance Ledger cryptographically bound to a TEE attestation report; generating Groth 16 arithmetic-circuit proofs of approximately 192 bytes verifiable in under 10 milliseconds for External Supervisory Authority verification of systemic containment compliance without exposure of proprietary exposure data; and releasing settlement path authorization only after completion within the TEE of CRT computation, Exposure Drift Monitor validation, Cascade Interruption Gate evaluation, ZKP proof generation, and Provenance Ledger recording within a single attested TEE execution instance prior to enclave termination.

3. A hardware-secured cascade interruption and exposure containment subsystem comprising a trusted execution environment (TEE) comprising an Intel SGX enclave, AMD SEV-SNP protected VM, or ARM TrustZone secure world materially altering the processor state by invoking secure enclave isolation; a Cascade Interruption Gate executing within the TEE configured to enforce deterministic cascade containment conditions as a non-bypassable pre-condition to settlement path authorization, evaluating Contagion Risk Tensor threshold satisfaction, Exposure Drift Monitor integrity confirmation, ZKP proof availability, and Settlement Path Router path validation within a single attested TEE execution instance prior to enclave termination; a Settlement Path Router executing within the TEE configured to dynamically authorize, re-route, or suspend inter-institution settlement pathways based on Cascade Interruption Gate outcomes, applying the same cascade threshold evaluation to all identified alternate settlement pathways within the same TEE execution instance to prevent cascade circumvention through path substitution; a Cascade Simulation Engine (also referred to herein as the Optimization and Simulation Engine) executing within the TEE configured to execute multi-node cascade propagation simulations and systemic stress tests using hardware-attested Contagion Risk Tensor values and Exposure Drift Monitor outputs, with drift detection anchored to TEE-resident hardware mechanisms comprising enclave-sealed monitoring registers, memory encryption engine integrity states, or attestation-based recalibration triggers; and an Attestation-Bound Provenance Ledger comprising an append-only cryptographic hash chain wherein each ledger entry is cryptographically bound to a TEE attestation report, enabling independent verification of both the cascade interruption outcome and the hardware environment that authorized it.

4. The system of claim 1, wherein the ZKP Contagion Verification Engine encodes systemic cascade threshold conditions, Contagion Risk Tensor constraint criteria, and Cascade Interruption Gate authorization conditions into Groth16 arithmetic circuit structures using cryptographic libraries including libsnark and circom, with Groth16 constant-size verification complexity independent of circuit depth ensuring the under-10-millisecond verification bound holds across all supported cascade risk assessment circuit configurations on standard server-grade hardware.

5. The system of claim 1, wherein the TEE-resident hardware mechanisms include memory encryption engine integrity states that encrypt all data stored in TEE memory pages, preventing extraction of cross-institution exposure data, Contagion Risk Tensor computation state, or cascade probability estimates through physical memory attacks, cold-boot attacks, or hypervisor-level memory inspection.

6. The system of claim 1, wherein the Exposure Drift Monitor triggers a hardware-level recalibration alert and suspends Cascade Interruption Gate processing when exposure correlation modeling input drift detected via TEE-resident hardware mechanisms exceeds the configurable tolerance threshold, requiring hardware-attested recalibration and generation of a new TEE attestation report before cascade detection processing resumes.

7. The system of claim 1, wherein the regulatory systemic-risk coefficients psi incorporate domain-specific regulatory coefficients applicable to systemically important financial institution capital surcharge requirements, macroprudential buffer frameworks, and applicable domestic and international systemic risk regulation, with all regulatory coefficients stored in a TEE-sealed policy store that cannot be modified without generating a new hardware attestation event.

8. The system of claim 1, wherein each Attestation-Bound Provenance Ledger entry comprises a cryptographic hash of the prior ledger entry chained with the TEE attestation measurement of the current TEE execution instance, such that modification of any historical entry propagates as a detectable hash chain inconsistency through all subsequent entries.

9. The system of claim 1, wherein the ZKP Contagion Verification Engine implements Groth16 proofs using trusted setup ceremonies performed inside a TEE, with proving key rotation tied to hardware attestation events and prior proving keys invalidated using enclave-sealed revocation lists.

10. The system of claim 1, further comprising a Cascade Simulation Engine executing within the TEE configured to execute multi-node cascade propagation simulations and systemic threshold sensitivity analyses using hardware-attested Contagion Risk Tensor values, generating recalibration recommendations cryptographically bound to the TEE attestation report of the simulation execution instance.

11. The system of claim 1, wherein the Cascade Interruption Gate enforces a mandatory execution barrier requiring that CRT computation, Exposure Drift Monitor validation, ZKP proof generation, and Settlement Path Router path validation complete within a single attested TEE execution instance prior to enclave termination before any settlement path authorization is released, with any incomplete or failed pipeline stage triggering the Rollback Controller.

12. The method of claim 2, wherein detecting exposure correlation drift triggers hardware-level recalibration of the Contagion Risk Tensor Engine using enclave-sealed monitoring registers, suspending cascade threshold evaluation until a new TEE attestation report is generated confirming recalibrated model integrity and a drift metric within the configured tolerance threshold.

13. The method of claim 2, wherein the Groth16 arithmetic-circuit proofs exhibit constant-size verification complexity independent of circuit depth, ensuring the under-10-millisecond verification bound holds regardless of the complexity of the systemic risk assessment circuit configuration on standard server-grade hardware.

14. The method of claim 2, further comprising binding each cascade detection and interruption event to a specific TEE attestation report identifier corresponding to the TEE execution instance in which the CRT computation and Cascade Interruption Gate evaluation were performed, enabling independent parties to verify that a specific hardware execution instance authorized a specific cascade interruption decision.

15. The system of claim 3, further comprising a Cross-Institution Verifier configured to route TEE-attested cascade detection outcomes and ZKP compliance proofs to applicable clearing houses, central counterparties, and External Supervisory Authorities across multiple participating institutions, maintaining a routing manifest in the Attestation-Bound Provenance Ledger with cryptographic binding to the originating TEE attestation report for each routing event.

16. The system of claim 3, further comprising a Multi-Party ZKP Coordinator executing within the TEE configured to generate authority-isolated Groth16 proofs for multiple External Supervisory Authorities and clearing houses participating in oversight of a single cascade detection event, preventing any authority from accessing another's proprietary supervisory data while enabling independent verification of systemic containment compliance by all authorities.

17. The system of claim 3, further comprising a Rollback Controller executing within the TEE configured to revert pending pipeline state for affected settlement pathways to their pre-ingestion checkpoints upon Cascade Interruption Gate denial or Exposure Drift Monitor suspension alert, recording the reversion event in the Attestation-Bound Provenance Ledger with full TEE attestation binding and initiating a re-attestation cycle before new cascade detection processing resumes.

18. The system of claim 3, further comprising a CRT Calibration Loop executing within the TEE configured to incorporate Multi-Node Stress Simulator outputs, post-interruption exposure resolution data, and Exposure Drift Monitor alerts into Contagion Risk Tensor Engine model parameter updates, with all calibration updates cryptographically bound to a new TEE attestation report before application to subsequent CRT computation events.

19. The system of claim 3, further comprising a Policy Coefficient Recalibrator executing within the TEE configured to translate Cascade Simulation Engine scenario outputs into recommended updates to the Contagion Risk Tensor Engine's regulatory systemic-risk coefficients psi and cascade probability thresholds tau, with proposed coefficient updates requiring Cascade Interruption Gate re-attestation confirming generation of a new TEE attestation report before application to new CRT computation events.

20. The system of claim 3, wherein the Attestation-Bound Provenance Ledger records cascade detection and interruption events with cryptographic hash-chain binding to specific TEE attestation report identifiers corresponding to the TEE execution instances in which the associated Contagion Risk Tensor computations, Exposure Drift Monitor validations, Cascade Interruption Gate evaluations, and Settlement Path Router actions were performed, enabling independent verification of both the cascade interruption outcome and the identity of the hardware execution environment that authorized each action in the interruption sequence.
